(19) United States
(12) Patent Application Publication
(10) Pub. No.: US 2012/0069317 A1
(43) Pub. Date: Mar. 22, 2012

(54) LITHOGRAPHY SYSTEM ARRANGED ON A FOUNDATION, AND METHOD FOR ARRANGING A LITHOGRAPHY SYSTEM ON SAID FOUNDATION

(76) Inventor: Jerry Peijster, Maartensdijk (NL)

(21) Appl. No.: 13/237,797

(22) Filed: Sep. 20, 2011

Related U.S. Application Data
(60) Provisional application No. 61/384,690, filed on Sep. 20, 2010.

(51) Int. Cl. G03B 27/58

(52) U.S. Cl. 355/72; 355/77

(57) ABSTRACT

The invention relates to a vibration isolation requiring system, such as a lithography system, arranged on a foundation, for example part of the floor in the room where the lithography system is arranged, and a method for arranging a lithography system on a foundation. The lithography system is arranged on top of a rigid or solid base plate, wherein said base plate having one or more struts attached thereto for placing the lithography system onto the foundation, wherein the one or more struts are arranged at a side of the base plate facing the foundation, and wherein the base plate is provided with a cut-out or an opening for mounting equipment underneath a vacuum chamber of the lithography system.

This is a non-provisional application claiming the benefit of U.S. Provisional Application No. 61/384,690, filed Sep. 20, 2010.

### BACKGROUND

The invention relates to a vibration isolation requiring system, such as a lithography system, arranged on said foundation. The invention further relates to a method for arranging a vibration isolation requiring system, such as a lithography system, on a foundation.

In lithography systems, for example in the manufacture of microelectronic devices (e.g. integrated circuits), the demands on accuracy and precision are extreme. Lithography involves the transfer of a pattern, used to define a layer of a microelectronic device, onto a surface of a suitable substrate such as a semiconductor wafer. Modern lithography systems are capable of providing patterns in which the pattern elements, as imaged or written on the substrate, having a sub-micron line width, e.g. less than one micrometer, on the substrate. Achieving such a high level of performance requires that all pattern transfer systems, positioning systems, and measuring systems of the lithography system operate at their absolute limits of performance. This level of performance also requires that the components of said lithography system are mounted at an accurate and substantially fixed position with respect to each other.

One approach is to mount the components of such a system on top of a stiff sandwiched base plate, such as a honeycomb type mounting platform. The honeycomb structures are usually used in areas where a lightweight, high stiffness vibration-free surface is required. The typical construction of the honeycomb base plate comprises a top plate and a bottom plate with a honeycomb or web structure bonded in between. The structures are known to be quite stiff when exposed to compressive loads applied normal to the top plate of the platform and it provides a rigid separation between the plates. However, such a honeycomb base plate is very expensive, complicated in design, and require a long ordering time.

Another approach is to mount the components on a thick, substantially monolithic slab of granite. However in order to obtain the desired stiffness to carry a lithography system, such a slab needs to be relatively thick, typically more than 300 mm, and as a consequence will be extremely heavy.

Another aspect of base plates is its dimensions and the associated volume of the base plates. Since lithography systems and their base plates are usually placed in well-conditioned (and therefore expensive) factory halls (so called fab space), large massive base plates tend to occupy a large volume in such a fab space.

It is an object of the present invention to provide a base structure for a lithography system which at least partially obviates one or more of the above mentioned disadvantages.

### SUMMARY OF THE INVENTION

According to a first aspect, the invention provides a lithography system arranged on top of a rigid or solid base plate, wherein said base plate having one or more struts attached thereto for placing the lithography system onto a foundation, wherein the one or more struts are arranged at a side of the base plate facing the foundation, and wherein the base plate is provided with a cut-out or an opening for mounting equipment underneath a vacuum chamber of the lithography system.

An advantage of such a base plate is that in its opening (or in other words: in its cutout) equipment of the lithography system may be at least partly provided, leaving more space available in the remainder of the system for other devices or parts. In this way the total volume of the lithography system may be decreased, thus saving space in the fab space.

In an embodiment the equipment comprises measuring equipment, such as a camera, of the lithography system.

In an embodiment the lithography system comprises a target positioning device, and wherein the equipment comprises a motor for driving the target positioning device of the lithography system.

In an embodiment the equipment extends through and preferably beyond the base plate. In an embodiment the equipment extends from the lithography system to a distance from the side of the base plate facing the foundation, said distance being substantially equal to a distance the struts extend from the side of the base plate facing the foundation. Usually a space is provided between the base plate and the floor, wherein the height of the space is substantially defined by the height of the struts. This space is usually not used by any part of the lithography system. According to this embodiment of the invention, this space may used by any device extending from the base plate (and preferably through the base plate).

In an embodiment, the lithography system comprises a vacuum camber, wherein a side of said equipment facing the lithography system is arranged inside the vacuum chamber.

In an embodiment, said lithography system further comprising a projection column having a centre line or optical axis, wherein the equipment, in particular the measuring system is arranged substantially in alignment with the centre line or optical axis of the projection column. Since the equipment, in particular the camera, may he used to study characteristics of the patterning beam of the lithography system (the patterning beam being a light beam or a charged particle beam such an electron beam), it is advantageous to align the camera with the centre line or optical axis of the projection column, wherein the projection column projects the patterning beam on a target such as a wafer.

In an embodiment, the base plate and the struts are made of aluminum, and preferably wherein the base plate and the struts are formed as one part. An advantage of this embodiment is that it prevents positioning errors when placing the struts on the base plate.

In an embodiment, the base plate and/or the struts form a monolithic structure.

In an embodiment, said base plate comprises a plate of granite or a plate of aluminum.

In an embodiment, said base plate is provided with mounting members at a top side for mounting the lithography system onto said base plate. In an embodiment, at least one strut is arranged below one mounting member.

In an embodiment, the base plate is a self-carrying base plate.

In an embodiment, the base plate is releasable arranged on the foundation and/or on the struts.

In an embodiment, the base plate is provided with three struts.

In an embodiment, said struts are rigidly connected to said foundation by a resin material.

In an embodiment, said one or more struts are at least partially submerged in said cured resin material.

In an embodiment, the resin material is a curable resin material having a low or substantially no shrinkage during curing. In an embodiment, said shrinkage is less than one percent.

In an embodiment, said curable resin material comprises a substantially non-shrinkable epoxy.

In an embodiment, said epoxy comprises substantially no or a minimal amount of solvent.

In an embodiment, said curable resin material comprises an adhesive.

In an embodiment, the foundation comprises a foundation plate. In an embodiment, the foundation plate is a concrete foundation plate.

According to a second aspect, the invention provides a lithography system arranged on a foundation,

wherein said foundation is provided with a self-carrying base plate having one or more struts attached thereto, wherein the one or more struts are attached to a side of said base plate that faces the foundation, wherein said one or more struts are rigidly connected to said foundation by a resin material, and

wherein said lithography system is arranged on top of said base plate.

According to a third aspect, the invention provides a base plate for use in a lithography system as described above.

According to a fourth aspect, the invention provides a base plate for supporting a vibration isolated lithography system, wherein the base plate comprises a bottom side that, in use, faces a foundation, wherein said bottom side is provided with struts or at least is prepared for receiving struts via screws or bolts, wherein said struts are arranged for arranging said base plate onto the foundation, such as a concrete foundation block.

In an embodiment, the struts and the base plate are formed as one unity. Alternatively, in an embodiment, said struts are releasable connected to said base plate via screws or bolts.

In an embodiment, the base plate comprises a top side that, in use, faces the lithography system, wherein said top side comprises one or more mounting members or at least is prepared for having one or more mounting members attached thereto.

In an embodiment, the lithography system comprises a vacuum chamber having a bottom wall, wherein said base plate is at least part of the bottom wall of said vacuum chamber. In an embodiment, the lithography system comprises a vacuum chamber having a bottom wall, wherein said base plate is the bottom wall of said vacuum chamber.

In an embodiment, the struts are rigidly connecting said base plate to the foundation. The base plate of the invention may be kept much thinner in order to arrive at a sufficient stiffness for supporting a vibration isolation requiring system. Advantages of such thinner base plate, apart form material and transportation costs, are that it may be produced quicker and transported more easily. In general a less complicated logistic preparation is required, e.g. the choice of transportation means is considerably enlarged, as well as the choice in sites capable of manufacturing such a base plate.

In an embodiment, said struts are releasable connected to said base plate. In this embodiment, the base plate may, if so desired, be easily and cost-effectively be replaced, for example in case of any system upgrade. Also, only a relatively small material part of the foundation system needs to be sacrificed for such an update.

A further advantage of said releasable struts is that the foundation may be prepared and/or the struts may be connected to the foundation while the base plate is being prepared an or transported. For preparing the foundation, a light weight, e.g. honeycomb stiffened mock-up plate may be used, rather than the original base plate. The mounting of the struts on to the foundation can be established without the presence of the base plate. When arrived, the base plate may instantly be positioned on the struts which are secured to the foundation.

In an embodiment, said base plate is self-carrying base plate.

In an embodiment, the base plate comprises a top side that, in use, faces the system, wherein said top side comprises one or more mounting members or at least is prepared for having one or more mounting members attached thereto, wherein said mounting members are connectable between said base plate and said system. Said base plate is provided with mounting members at the top side for mounting the system, such as a lithography system, onto said base plate.

In an embodiment, at least one of said mounting members is arranged at least partially in line with at least one of said struts. In an embodiment, at least one strut is arranged below one mounding member.

In an embodiment, at least one of said struts is provided with anchoring members at a side facing away from said base plate.

In an embodiment, said plate is provided with bores having a threaded insert fixedly received therein for connecting any of said struts and/or mounting members to said base plate.

In an embodiment, said base plate comprises a plate of granite.

According to a fifth aspect, the invention provides a method for arranging a vibration isolation requiring system, such as a lithography system on a foundation, said method comprising the steps of:

providing a self-carrying rigid base plate having one or more struts attached thereto, wherein the one or more struts are attached to a side of said base plate that faces the foundation;

placing said base plate with its struts onto said foundation;

providing leveling means for adjusting the distance between the base plate and the foundation;

adjusting the distance between the base plate and the foundation in order to obtain a desired leveling of the base plate;

providing a curable resin material between the struts and the foundation;

curing said resin material in order to provide a rigid connection between the foundation and the struts; and

placing said system on top of said base plate.

Using this method a base structure is provided wherein the foundation is used as a reinforcing part of the base plate in order to obtain the desired stiffness. In realizing that the foundation can be used as a reinforcing part for a base plate in a high precision environment, the rigid base plate of the base structure of the invention needs only to be self-carrying, that is having a sufficient stiffness that the base plate substantially does not bent under its own weight. In this patent application, the foundation is a load-bearing part in a building for bearing the load of the lithography system, such as a lowest load-bearing part of the building or part of the floor in the room where the lithography system is arranged.

Since the rigid base plate in itself does not need to be sufficient stiff to support the whole lithography system, the base plate can be of a relatively simple design. Such a base plate may be ordered and pre-installed by a customer of said lithography system, without undue costs of (overseas) transport.

Since a curable resin material is used to provide a rigid connection between the foundation and the struts of said rigid base plate, the method of the invention allows for fixing the base plate to an even rough and simple top surface of said foundation in a correct and strengthening manner. The leveling means can correct for any deviation of said foundation from a flat, horizontal surface. In addition, the curable resin material fills any space between the struts and the foundation, and provides sufficient strength after curing to support the rigid base plate and the system arranged on said base plate.

In an embodiment said method further comprising the step of removing the leveling means. Thus the leveling means are only required during the arrangement of the rigid base plate on the foundation and the connecting of said struts of said base plate to said foundation by means of said curable resin material. After curing the leveling means can be removed. Said leveling means comprises, for example, one or more hydraulic lifting jacks, screw jacks or lifting screws.

In an embodiment said method further comprising the steps of:

providing a rim onto the foundation, which rim surrounds a foundation area for said base plate; and

providing said curable resin material onto the foundation area as a pool of curable resin material, wherein the one or more struts are in contact with said pool of curable resin material, preferably wherein all struts are completely in contact with said pool of curable resin.

The resin material, after it has cured, provides a substantially continue top layer of resin material covering said foundation area within the rim. Such a top layer of resin material provides a large adhesion surface, and thus a good adhesion to the foundation.

In an embodiment, said one or more struts are at least partially submerged in said pool of curable resin material. This provides a mechanical bond between the struts and the top layer of resin material.

In an embodiment said curable resin material comprises an adhesive. This provides a chemical bond between the struts and the top layer of resin material.

In a preferred embodiment said one or more struts are at least partially submerged in a pool of adhesive, which provides both a mechanical and a chemical bond between the struts and the top layer.

Although the rim may be removed after the curing of said curable resin, it is preferred to use a decorative rim. By using a decorative rim, there is no need to remove the rim, which is a difficult procedure because the rim tends to stick to the curable resin material.

In an embodiment, said curable resin material is a material having a low or substantially no shrinkage during curing. In an embodiment, said shrinkage is less than one percent. Using a curable resin material with a low shrinkage at least substantially maintains the absolute position between the rigid base plate and the foundation before, during and after the curing of the resin material. Furthermore, the use of a low shrinkage resin material substantially prevents the building up of any stress inside the resin material during the curing thereof.

In an embodiment, said curable resin material comprises a substantially non-shrinkable epoxy. In an embodiment, said epoxy comprises substantially no or a minimal amount of solvent.

In an embodiment, the one or more struts are releasable connected to the base plate. This embodiment allows for replacing a base plate once the struts are connected and/or bonded to the foundation. The releasable connection provides fro an easy and relatively inexpensive upgrade facility.

It is preferred that the bottom surface of the base plate is substantially flat. Such a base plate with a flat bottom surface can be readily exchanged by another base plate. Preferably also the top surface of the base plate is substantially flat.

In an embodiment, the foundation comprises a foundation plate or block. In an embodiment, the foundation plate or block is a concrete foundation plate or block, or a reinforced concrete foundation plate or block. Such a foundation plate or foundation block may he manufactured on site.

In an embodiment, said has plate comprises a plate of granite. Since said base plate only needs to be self-carrying, the plate of granite can be relatively thin, in particular 150 mm or less, preferably 100 mm or less. Such a relatively thin granite base plate can be ordered locally, e.g. near to the site of the customer, and pre-installed on the foundation without undue costs of transport.

In an embodiment, said base plate is provided with mounting members at a top side for mounting the lithography system onto said base plate. The mounting members, such as interfaces or connectors, can be accurately positioned on said base plate in correspondence with the position of supporting members of said lithography system, enabling a quick installing of said lithography system onto said base plate.

In an embodiment, at least one strut is arranged below one mounting member, preferably below the centre line thereof. This provides for a direct transfer of the weight of the lithography system as carried by said mounting member, via said at least one strut to said foundation.

According to a sixth aspect, the invention relates to a use of the above mentioned base plate for supporting a vibration isolation requiring system, such as a lithography system. An other example of such a vibration isolation requiring system is a microscope system, such as an electron microscope or an atomic force microscope.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached drawings, in which:

FIG. 1 is a schematic presentation of a rigid base plate of the invention;

FIGS. 2 to 5 present a schematic side view of various steps of a first example of a method for arranging a lithography system on a foundation, in particular a floor area;

FIGS. 6 to 8 present a schematic side view of various steps of a second example of a method for arranging a lithography system on a foundation, in particular a foundation block; and

FIG. 9 present a schematic cross section of a lithography system according to an embodiment of the invention.

### DETAILED DESCRIPTION OF THE INVENTION

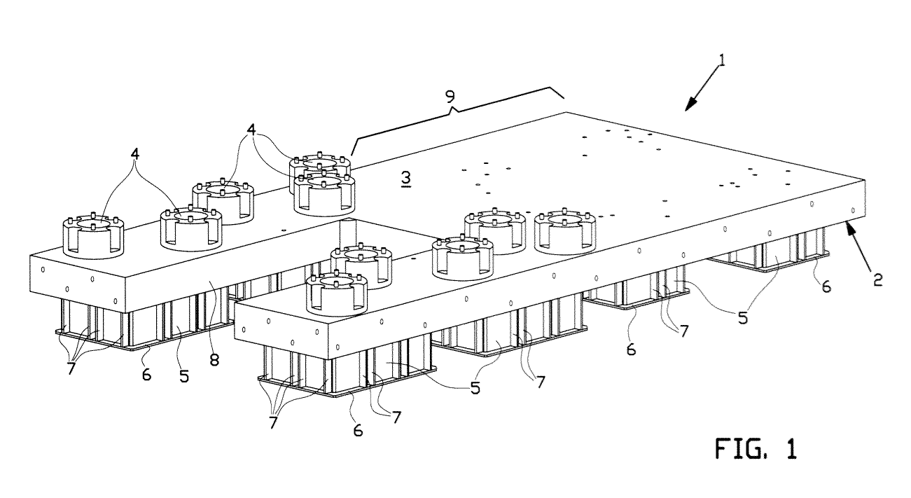

FIG. 1 shows a self-carrying rigid base plate 1 for placing a lithography system onto a foundation. Said base plate 1 may for example comprise a relatively thin honeycomb type mounting platform. However preferably the base plate 1 comprises a relatively thin monolithic plate of granite. The base plate 1 is provided with eight struts 5 attached to a bottom side 2 of said base plate 1 that, in use, faces the foundation.

The struts 5 are releasable attached to the bottom side 2 via screws or bolts. Each strut 5 comprises a substantially square cylinder having substantially flat side walls, which are for example 10 cm high. The struts 5 are manufactured using a profiled or moulded wall material, in order to provide strong and/or rigid struts. The upper end and lower end of each strut 5 is provided with a flange 6. The flange 6 extends approximately 5 cm beyond the outer side of the side walls of the strut 5. Between the flange at the upper end (not shown) and the flange 6 at the lower end, strengthening ribs 7 are provided. The strengthening ribs 7 are rigidly connected, for example by welding, to the upper and lower flange and to one of the side wall. In use the ribs 7 extend substantially vertically between the upper and lower flange 6.

The lower flange 6 is used as an anchoring member for connecting the strut 5 to the foundation as described in more detail below.

The lithography system or a part thereof, may be mounted directly on top of the base plate 1 surface 3. In the embodiment shown in FIG. 1, the top side 3 of said base plate 1 is provided with mounting members 4 for mounting the lithography system, in particular the vacuum chamber of said system, onto said base plate 1.

As shown in FIG. 1, the mounting members 4 are provided on a part of the base plate 1. This part is also provided with an opening or cut-out 8 which provides space for mounting equipment underneath the vacuum chamber of the system, in particular measuring equipment, such as a camera. In prior art base plates, such a cut-out 8 cannot be made because it considerably decreases the rigidity of the base plate. In the base plate 1 of the invention, where the foundation or floor is used as a reinforcing part for a base plate 1, the cut-out 8 substantially does not lessen the rigidity of the base plate 1 which is connected to the foundation or floor.

In order to pass the weight of the vacuum chamber of the lithography system on to the foundation or floor one or more of the mounting members 4 are arranged above one strut 5.

As shown in FIG. 1, the struts 5 below the part of the base plate 1 which is provided with the mounting members 4 for mounting the vacuum chamber of the lithography system, are larger than the other struts. In this example, ten mounting members 4 are evenly arranged above the four large struts 5.

As shown in FIG. 1, a second part 9 of the base plate 1 is not provided with mounting members 4. This part is used for mounting wafer handling equipment and actuators.

Before installing a lithography system, the above described base plate 1 is placed at the location where the system has to be installed. The base plate 11 with its struts 15 is arranged on a foundation 10, which is substantially separate from a surrounding floor 30. This can at least partially stop vibrations in or on the floor from reaching the foundation 10 and be transmitted to the base plate 11.

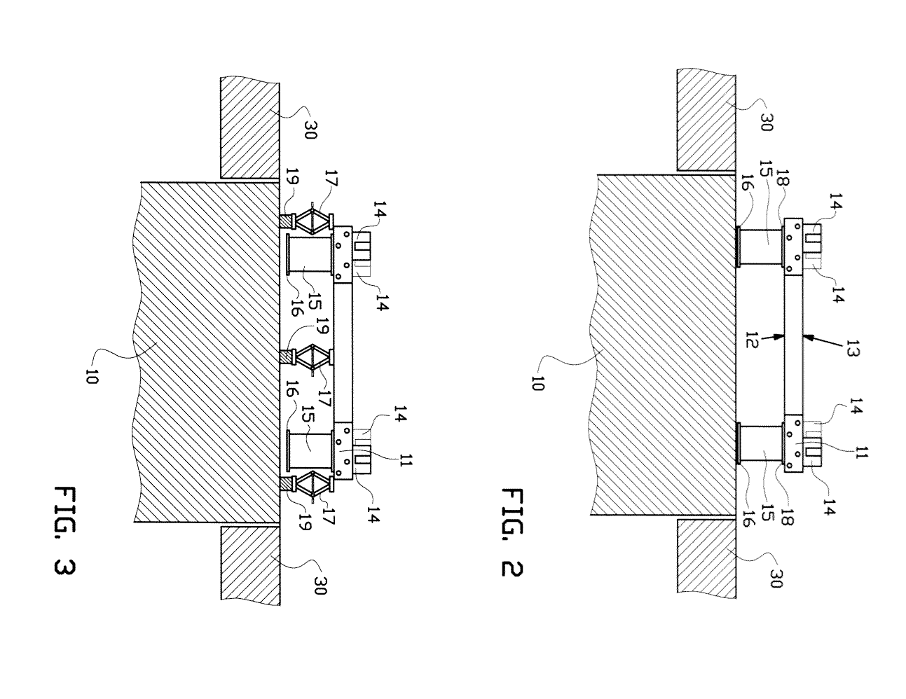

As shown in FIG. 2, the self-carrying rigid base plate 11, having one or more struts 15 attached thereto, is provided. The upper end of the struts 15 is provided with an upper flange 18 which is attached to a flat bottom side 12 of said base plate 11 that faces the foundation 10. The lower end of the struts 15 are provided with a lower flange 16, which acts as an anchoring member. As shown in FIG. 2, said base plate 11 is placed with its struts 15 onto said foundation 10. Furthermore the top side 13 comprises the mounting members 14.

Subsequently leveling means 17, in particular screw jacks or lifting screws, for adjusting the distance between the base plate 11 and the foundation 10, are provided. As shown in FIG. 3, the leveling means 17 are placed on top of blocks 19. The leveling means 17 are used for adjusting the distance between the base plate 11 and the foundation 10 in order to obtain a desired leveling of the base plate 11.

On the one hand, the curable resin material 21 can be provided locally, that is only at or near the anchoring members of the struts 15.

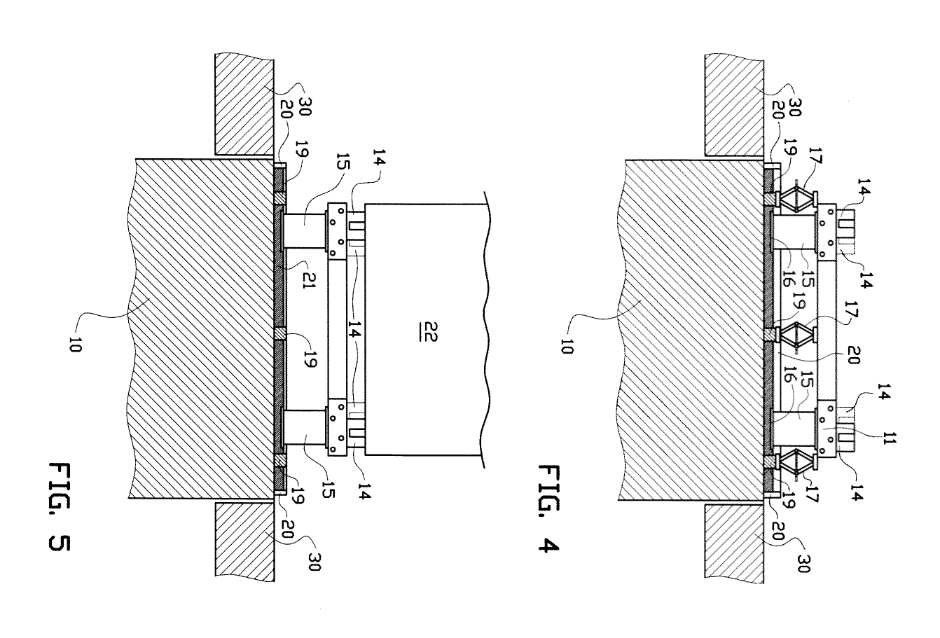

On the other hand, the curable resin material 21 can be made to cover the foundation area at and near the base plate 11. This option is chosen in the example in FIG. 4. Before providing the curable resin material 21, a rim 20 is placed onto the foundation 10, which rim 20 surrounds a area for said base plate 11. Subsequently the curable resin material 21 is provided onto the foundation area as a pool of curable resin material, wherein the anchoring members 16 of all struts 15 are wholly in contact with said pool of curable resin material 21. Said curable resin material 21 comprises a substantially non-shrinkable epoxy, such as a two-component epoxy (Rocapox EP™ from the firm Prokol) with our without a filler. This material has a low or substantially no shrinkage during curing, in particular a shrinkage of less than one percent.

As shown in FIG. 4, the curable resin material 21 is also provided between the anchoring members 16 of the struts 15 and the foundation 10. The anchoring members 16 of the all struts 15 are completely in contact with said pool of curable resin material 21. After the resin material 21 has set or cured, it provides a rigid connection between the floor 10 and the struts 15.

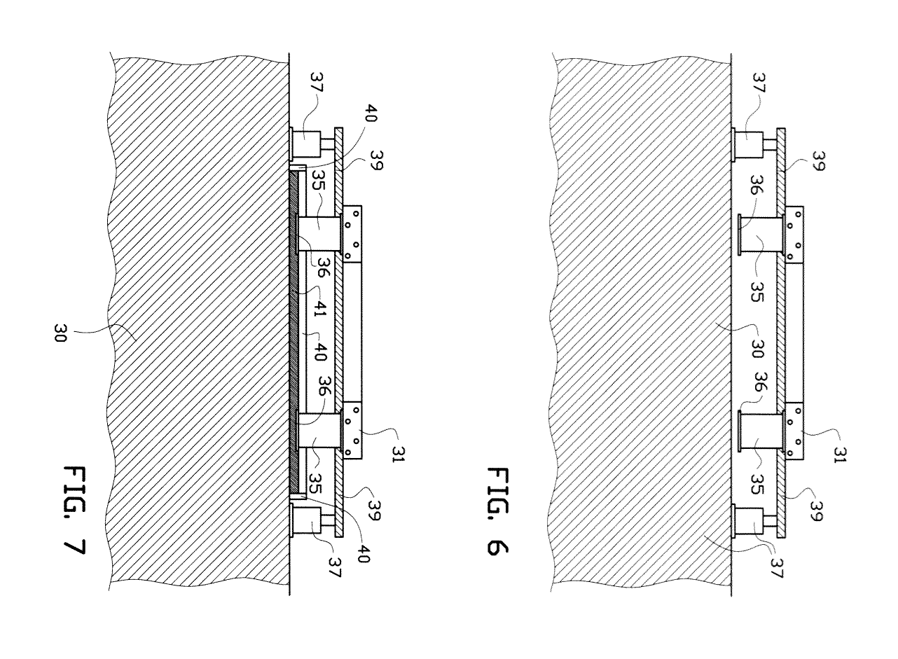

Now the leveling means 17 can be removed and the base plate 11 attached on the foundation 10 is ready to receive the lithography system 22, as schematically depicted in FIG. 5.

In a second example, as shown in FIG. 6, the location comprises a solid floor 30. The base plate 31 can be placed directly onto that floor 30.

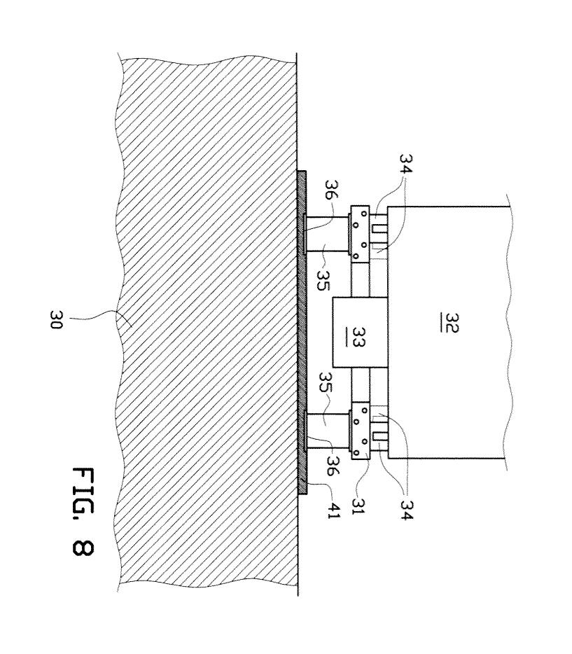

Furthermore, as shown in FIG. 6, the leveling means comprises one or more beams 39 which reach underneath the base plate 31, and wherein each beam 39 rests on two hydraulic jacks 37 for adjusting the distance between the base plate 31 and the floor 30. As shown in FIG. 6, the hydraulic jacks 37 are placed at a distance from the base plate 31, outside the floor area that is destined to be covered by the curable resin material 40, as shown in FIG. 7. The hydraulic jacks 37 are used for adjusting the distance between the base plate 31 and the floor 30 in order to obtain a desired leveling of the base plate 31. Preferably the hydraulic jacks 37 are provided with mechanical locking or retaining members in order to secure the position of the base plate 31 after leveling.

Before providing the curable resin material 41, a rim 40 is placed onto the floor 30, which rim 40 surrounds a floor area for said base plate 31. Subsequently the curable resin material 41 is provided onto the floor area as a pool of curable resin material, wherein the flanges 36 which act as anchoring members of the struts 35 are all, substantially completely, in contact with said pool of curable resin material 41. Said curable resin material 21 comprises a substantially non-shrinkable epoxy that comprises substantially no or a minimal amount of solvent, for example Rocapox EP™ from the firm Prokol. Alternatively an substantially non-shrinkable adhesive can be use.

As shown in FIG. 7, the curable resin material 41 is also provided between the anchoring members 36 of all struts 35 and the floor 30. After the resin material 41 has set or cured, it provides a rigid connection between the floor 30 and the struts 35.

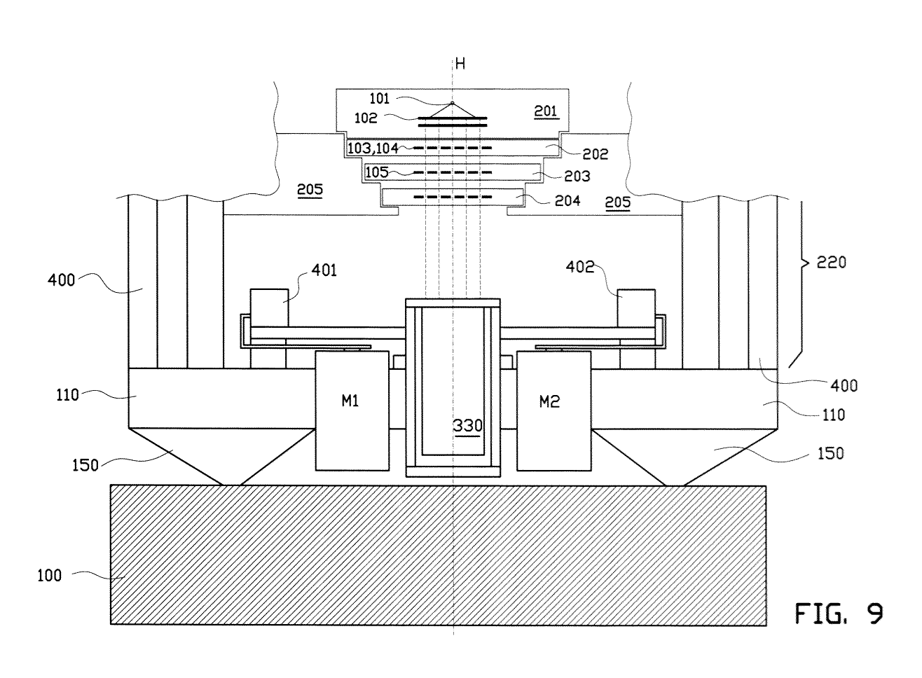

Now the leveling means 37, 39 and the rim 40 can be removed and the base plate 11 attached on the floor 30 is ready to receive the lithography system 32, as schematically depicted in FIG. 8. The lithography system 32 is at its bottom side provided with a camera 33 which is arranged in the cut-out 8 of the base plate 31 analogous as in the base plate 1 of FIG. 1.

FIGS. 5 and 8 thus show a lithography system 22, 32 arranged on a floor 30 or a foundation 10, wherein said floor 30 or foundation 10 is provided with a self-carrying rigid base plate 11, 31 having one or more struts 15, 35 attached thereto, wherein the one or more struts 15, 35 are attached to a side of said base plate 11, 31 that faces the floor 30 or foundation 10, wherein said one or more struts 15, 35 are provided with anchoring members at a side facing away from said base plate 11, 31, wherein said anchoring members are rigidly connected to said floor 30 or said foundation 10 by a cured resin material 21, 41, and wherein said lithography system 22, 32 is arranged on top of said base plate 11, 31.

FIG. 9 shows a schematic cross section of a lithography system according to an embodiment of the invention. In this embodiment, the base plate 110 is preferably made from a thick and rigid block of metal such as aluminum. The thickness of the base plate 110 may be in the range of 25-30 cm.

The base plate may be provided with struts 150 (preferably three struts) for supporting the system on the foundation 100. The struts 150 may be formed as an integral part of the base plate 110, where in the metal base plate may be machined in one process to form the struts 150 and interfaces to other components (for example to mounting members 14) in one process from a block of metal with high accuracy.

The struts 150 may have take the form of inverted pyramids with three or more sides and a flattened portion at the peak of the pyramid where each strut 150 rests on the foundation 100 as shown in FIG. 9.

The lithography system may be provided with an charged particle optical column, which is partly shown in FIG. 9. The optical column is arranged for projecting one or more patterning beams onto a target, such as a wafer, in the lithography system.

In the embodiment shown in FIG. 9, the lithography system includes:

an illumination optics module 201 including the charged particle beam source 101 and beam collimating system 102,

an aperture array and condenser lens module 202 including aperture array 103 and condenser lens array 104,

a beam switching module 203 including beamlet blanker array 105, and

projection optics module 204 including beam stop array, beam deflector array, and projection lens arrays. As shown in FIG. 9, these modules are arranged in a frame 205 which is arranged inside a vacuum chamber bounded by side walls 400. In the embodiment of FIG. 9, the base plate 110 acts as the bottom wall of the vacuum chamber.

Under the projection optics module, usually a stage or stage assembly is arranged which carries a carrier, which in use carries the target. The stage or stage assembly can move the carrier with respect to the projection optics module. The carrier (not shown) may comprise the wafer table, the chuck and the short stroke stage.

In FIG. 9 only part of the stage is shown. FIG. 9 shows the long stroke stage for carrying and moving the carrier (not shown) along a first direction (X). The long stroke stage comprises two X-stage carriages 401, 402, both arranged on top of the base plate 110, wherein each X-stage base carries an X-stage carriage. Said base plate 110 is provided with two openings or cut-outs in which one of two motors M1, M2 are arranged, each for driving a corresponding X-stage carriage 401, 402. Arranging the two motors M1, M2 in openings of the base plate 110, and partially outside and under the vacuum chamber, provides a compact design which occupies less space in the factory halls, such as a clean room.

In FIG. 9, the carrier (not shown) is actually shifted to the back of the system in order to allow the patterning beams to reach the measuring equipment 330, in particular a camera.

The base plate 110 is provided with an opening or cut-out in which camera 330 is provided. The camera extends through the base plate 110. The camera also extends from the base plate both in the direction of the foundation 100 and in the direction of the optical column. The camera is aligned with the optical column, in particular with a centre line or optical axis H thereof, in order to measure and/or to study the patterning beam or beams.

It is advantageous to provide access to the camera 330 from the inside of the lithography system, in particular from the inside of the vacuum chamber. Otherwise the lithography system needs to be removed from its base plate 110 and/or its foundation 100 in order to access the camera 330 for servicing it. Another solution would be creating extra space between the base plate 110 and the foundation 100, such that the camera 330 may be accessed through this extra space. However, creating extra space between the base plate 110 and the foundation 100 would have disadvantage of increasing the volume the lithography system occupies in the fab space.

The lithography system may be provided with a vacuum chamber in which the optical column may be provided as well as the target. In an embodiment, the base plate 110 form a part of said vacuum chamber.

Any other part of the lithography may also be provided in a opening or cut-out of the base plate 110 instead of camera 330 or motors M1, M2 (or in other openings or cut-outs in the base plate), having the effect of minimizing the volume of the lithography system inside the fab space.

When operating the lithography system, the patterning beams are first measured and/or studied (or more particular: calibrated) using the camera 330. During this, the carrier and the target are not positioned in the patterning beam (as shown in FIG. 9) and the patterning beam is received by the camera 330. After the calibration of the patterning beam, the carrier with a target, such as a wafer, is moved between the projection optics 204 and the camera 330 in the patterning beams and the camera 330 does not receive the patterning beams anymore. Subsequently, the target on top of the carrier is processed using the patterning beams.

In summary, the invention relates to a vibration isolation requiring system, such as a lithography system, arranged on a foundation, for example part of the floor in the room where the lithography system is arranged, and a method for arranging a lithography system on a foundation. The lithography system is arranged on top of a rigid or solid base plate, wherein said base plate having one or more struts attached thereto for placing the lithography system onto the foundation, wherein the one or more struts are arranged at a side of the base plate facing the foundation, and wherein the base plate is provided with a cut-out or an opening for mounting equipment underneath a vacuum chamber of the lithography system.

In an embodiment, the one or more struts are rigidly connected to the foundation by a cured resin material. This provides a base structure wherein the foundation is used as a reinforcing part of the base plate in order to obtain the desired stiffness. The said lithography system is arranged on top of said base plate.

It is to be understood that the above description is included to illustrate the operation of the preferred embodiments and is not meant to limit the scope of the invention. From the above discussion, many variations will be apparent to one skilled in the art that would yet be encompassed by the spirit and scope of the present invention.

1. Lithography system arranged on top of a rigid or solid base plate, wherein said base plate having one or more struts attached thereto for placing the lithography system onto a foundation, wherein the one or more struts are arranged at a side of the base plate facing the foundation, and wherein the base plate is provided with a cut-out or an opening for mounting equipment underneath a vacuum chamber of the lithography system.

2. Lithography system according to claim 1, wherein the equipment comprises measuring equipment, such as a camera, of the lithography system.

3. Lithography system according to claim 1, wherein the lithography system comprises a target positioning device, and wherein the equipment comprises a motor for driving the target positioning device of the lithography system.

4. Lithography system according to claim 1, wherein the equipment extends through and preferably beyond the base plate.

5. Lithography system according to claim 1, wherein the equipment extends from the lithography system to a distance from the side of the base plate facing the foundation, said distance being substantially equal to a distance the struts extend from the side of the base plate facing the foundation.

6. Lithography system according to claim 1, wherein lithography system comprises a vacuum chamber, wherein a side of said equipment facing the lithography system is arranged inside the vacuum chamber.

7. Lithography system according to claim 2, further comprising a projection column having a centre line or optical axis, wherein the measuring system is arranged substantially in alignment with the centre line or optical axis of the projection column.

8. Lithography system according to claim 1, wherein the base plate and the struts are made of aluminum, and preferably wherein the base plate and the struts are formed as one part.

9. Lithography system according to claim 1, wherein the base plate and/or the struts form a monolithic structure.

10. Lithography system according to claim 1, wherein the base plate is a self-carrying base plate.

11. Lithography system according to claim 1, wherein the base plate is releasable arranged on the foundation.

12. Lithography system according to claim 1, wherein the base plate is provided with three struts.

13. Lithography system according to claim 1, wherein said struts are rigidly connected to said foundation by a resin material.

14. Lithography system according to claim 13, characterized in that said resin material is a curable resin material having a low or substantially no shrinkage during curing.

15. Lithography system according to claim 14, characterized in that said shrinkage is less than one percent.

16. Lithography system according to claim 14, characterized in that said curable resin material comprises a substantially non-shrinkable epoxy.

17. Lithography system according to claim 16, characterized in that said epoxy comprises substantially no or a minimal amount of solvent.

18. Lithography system according to claim 14, characterized in that said curable resin material comprises an adhesive.

19. Base plate for use in a Lithography system according to claim 1.

20. Base plate for supporting a vibration isolated lithography system, wherein the base plate comprises a bottom side that, in use, faces a foundation, wherein said bottom side is provided with struts or at least is prepared for receiving struts via screws or bolts, wherein said struts are arranged for arranging said base plate onto the foundation, such as a concrete foundation block.

21. Base plate according to claim 20, wherein the struts and the base plate are formed as one unity.

22. Base plate according to claim 20, wherein said struts are releasable connected to said base plate via screws or bolts.

23. Base plate according to claim 20, wherein the base plate comprises a top side that, in use, faces the lithography system, wherein said top side comprises one or more mounting members or at least is prepared for having one or more mounting members attached thereto.

24. Base plate according to claim 20, wherein the lithography system comprises a vacuum chamber having a bottom wall, wherein said base plate is at least part of the bottom wall of said vacuum chamber.

25. Base plate according to claim 20, wherein the lithography system comprises a vacuum chamber having a bottom wall, wherein said base plate is the bottom wall of said vacuum chamber.

26. Base plate according to claim 23, wherein at least one of said mounting members is arranged at least partially in line with at least one of said struts.

27. Base plate according to claim 20, wherein at least one of said struts is provided with anchoring members at a side facing away from said base plate.

28. Base plate according to claim 20, wherein said plate is provided with bores having a threaded insert fixedly received therein for connecting any of said struts and/or mounting members to said base plate.

29. Base plate according to claim 20, wherein the base plate is a monolithic slab.

30. Base plate according to claim 29, wherein said slab is made of granite or aluminum.

31. Method for arranging a vibration isolation requiring system, such as a lithography system, on a foundation, said method comprising the steps of:
providing a self-carrying rigid base plate having one or more struts attached thereto, wherein the one or more struts are attached to a side of said base plate that faces the foundation;
placing said base plate with its struts onto said foundation;
providing leveling means for adjusting the distance between the base plate and the foundation;
adjusting the distance between the base plate and the foundation in order to obtain a desired leveling of the base plate;
providing a curable resin material between the struts and the foundation;
curing said resin material in order to provide a rigid connection between the foundation and the struts; and
placing said system on top of said base plate.

32. Method according to claim 31, further comprising the step of removing the leveling means.

33. Method according to claim 31, further comprising the steps of:
providing a rim onto the foundation, which rim surrounds a foundation area for said base plate; and
providing said curable resin material onto the foundation area as a pool of curable resin material, wherein the one or more struts are all in contact with said pool of curable resin material.

34. Method according to claim 33, wherein said struts are at least partially submerged in said pool of curable resin material.

35. Method according to claim 33, further comprising the step of removing the rim after the curing of said curable resin material.
